(19) United States
(12) Patent Application Publication
(10) Pub. No.: US 2019/0330467 A1
(43) Pub. Date: Oct. 31, 2019

(54) POLYCARBONATE RESIN COMPOSITION

(71) Applicant: Daicel Polymer Ltd., Minato-ku, Tokyo (JP)

(72) Inventor: Ippei TONOSAKI, Himeji-shi, Hyogo (JP)

(21) Appl. No.: 16/462,013

(22) PCT Filed: Nov. 29, 2017
(86) PCT No.: PCT/JP2017/042834

§ 371 Date: May 17, 2019

(30) Foreign Application Priority Data
Nov. 29, 2016 (JP) 2016-231179

(51) Int. Cl. C08L 69/00

(52) U.S. Cl. CPC C08L 69/00; C08L 2205/03; C08L 2207/20; C08L 2205/025

(57) ABSTRACT

A polycarbonate resin composition containing, relative to 100 parts by mass of a resin composed of: (A) 40 to 100% by mass of a recycled aromatic polycarbonate resin; and (B) 0 to 60% by mass of an aromatic polycarbonate resin to amount to a total of 100% by mass, (C) 10 to 60 parts by mass of carbon fibers, (D) 20 to 40 parts by mass of a phosphate compound, and (E) 0.01 to 1 part by mass of a fluorine compound, wherein component (A) has a viscosity average molecular weight of 19,000 to 30,000, and component (B) has a viscosity average molecular weight of 19,000 to 30,000.

### FIELD OF THE INVENTION

The present invention relates to a polycarbonate resin composition containing a recycled polycarbonate resin.

### BACKGROUND OF THE INVENTION

Enclosures of electronic devices such as notebook computers and mobile phones require high rigidity. Thus, in these products, polycarbonate resins or polyamide resins reinforced with glass fibers or carbon fibers have been conventionally used. Especially when flame retardancy is required, polycarbonate resins added with a phosphorus-based flame retardant are used for coping with an environment.

Meanwhile, use of recycled resins in packaging and enclosures of electronic devices has recently been required mainly in Europe and the United States. There are also moves to tighten regulations by systems such as the Blue Angel in Germany and Electronic Products Environmental Assessment Tools (EPEAT) in the United States. In view of the above, it is necessary to satisfy various environmental standards by using recycled materials in resin compositions.

JP-A 9-316316 describes an aromatic polycarbonate resin composition in which an aromatic polycarbonate resin is used as a base material, and which is obtained by using a pulverized product of no-longer-used unnecessary optical disks as they are without removal of metal films, ink, UV coating, and the like attached thereto, has high glossiness and is satisfactory in rigidity, flowability, and appearance.

JP-A 2001-49109 describes an aromatic polycarbonate resin composition having high rigidity, excellent impact strength, and wet heat resistance while maintaining electroconductivity of carbon fibers.

JP-A 2014-31482 describes a thermoplastic resin composition capable of obtaining a molded article excellent in electromagnetic wave shielding properties.

### SUMMARY OF THE INVENTION

The object of the present invention is to provide a polycarbonate resin composition that uses a recycled material as a component of the resin composition and is capable of providing a molded article having excellent flame retardancy and material strength, and a molded article therefrom.

The present invention provides a polycarbonate resin composition containing, relative to 100 parts by mass of a resin composed of:

(A) 40 to 100% by mass of a recycled aromatic polycarbonate resin and

(B) 0 to 60% by mass of an aromatic polycarbonate resin to amount to a total of 100% by mass,

(C) 10 to 60 parts by mass of carbon fibers,

(D) 20 to 40 parts by mass of a phosphate compound, and

(E) 0.01 to 1 part by mass of a fluorine compound,

wherein component (A) has a viscosity average molecular weight of 19,000 to 30,000, and component (B) has a viscosity average molecular weight of 19,000 to 30,000.

According to the polycarbonate resin composition of the present invention, it is possible to provide a molded article having excellent flame retardancy and material strength by use of a recycled material.

### Embodiments of the Invention

A recycled aromatic polycarbonate resin as component (A) is an aromatic polycarbonate resin that has been recovered from molded articles in which an aromatic polycarbonate resin is used as the base material. Component (A) may be an aromatic polycarbonate resin recovered from materials and defective products generated from the disposal route of a manufacturing process of molded articles (pre-consumer recycling), or may be an aromatic polycarbonate resin recovered from used molded articles shipped to the market (post-consumer recycling), among molded articles in which the aromatic polycarbonate resin is used as the base material. From the viewpoint of further enjoying the effects of the present invention, the aromatic polycarbonate resin recovered from used molded articles shipped to the market is preferable.

Examples of the type of molded article from which the aromatic polycarbonate resin is recovered include (1) beverage containers such as water bottles for water servers, canteens, and nursing bottles, (2) optical components such as camera lenses, automotive headlamps, and light guide plates, (3) electronic component enclosures such as pachinko board cases, (4) transport cases for electronic components such as silicon wafers and microchips, (5) building materials such as corrugated plates and carport plates, and (6) optical recording media such as CDs and DVDs. It is possible to use an aromatic polycarbonate resin recovered from one or two or more of these molded articles.

As component (A), preferable is an aromatic polycarbonate resin recovered from one or more molded articles selected from optical recording media, beverage containers, optical components, electronic component enclosures, transport cases for electronic components, and building materials.

As the aromatic polycarbonate resin, a bisphenol type polycarbonate resin (polycarbonate resin including a bisphenol as a polymerization component) is preferable.

Examples of the bisphenol can include bis(hydroxyphenyl)alkanes [e.g., bis(hydroxyphenyl)C₁₋₆ alkanes such as bis(4-hydroxyphenyl)methane, 1,1-bis(4-hydroxyphenyl)ethane, 2,2-bis(4-hydroxyphenyl)propane (bisphenol A), 2,2-bis(4-hydroxy-3-methylphenyl)propane, 2,2-bis(4-hydroxyphenyl)butane, and 2,2-bis(4-hydroxyphenyl)-3-methylbutane], bis(hydroxyaryl)cycloalkanes [e.g., bis(hydroxyphenyl)C₄₋₁₀ cycloalkanes such as 1,1-bis(4-hydroxyphenyl)cyclopentane and 1,1-bis(4-hydroxyphenyl)cyclohexane], bis(hydroxyphenyl)ethers [e.g., bis(4-hydroxyphenyl)ether], bis(hydroxyphenyl)sulfones [e.g., bis(4-hydroxyphenyl)sulfone], and bis(hydroxyphenyl)sulfides [e.g., bis(4-hydroxyphenyl)sulfide]. One of these bisphenols may be used singly or two or more of these may be used in combination.

For improving the flame retardancy, the bisphenol may be halogenated with bromine or the like. Among these bisphenols, bis(hydroxyaryl)C₁₋₆ alkanes such as bisphenol A are preferable.

The viscosity average molecular weight of component (A) is preferably 19,000 to 30,000, more preferably 20,000 to 29,000, and further preferably 21,000 to 28,000. When component (A) has a viscosity average molecular weight of less than 19,000, molded articles are inferior in flame retardancy and flexural strength.

Even when component (A) of the present invention is an aromatic polycarbonate resin recovered from two or more molded articles, it is possible to achieve the effects of the present invention as long as the viscosity average molecular weight of component (A) is within the range described above as a whole.

The viscosity average molecular weight (Mv) of component (A) herein is a value calculated from the Schnell's viscosity equation: [η]=1.23×10⁻⁴Mv^{0.83}, wherein the intrinsic viscosity ([η]) (unit: dl/g) at a temperature of 20° C. is determined using methylene chloride as the solvent and an Ubbelohde viscometer.

Component (B) is an aromatic polycarbonate resin other than component (A). In other words, component (B) is a polycarbonate resin that has not been used for production of molded articles (virgin), not containing aromatic polycarbonate resins recovered from materials and defective products generated from the disposal route of a manufacturing process of molded articles and aromatic polycarbonate resins recovered from used molded articles shipped to the market.

As compounds of the aromatic polycarbonate resin of component (B), the compounds described for component (A) can be used.

Examples of component (B) include aromatic polycarbonate resins, for example, polycarbonates obtained by allowing a divalent phenol to react with a carbonate precursor [e.g., a carbonyl halide (such as phosgen), a carbonyl ester (such as diphenyl carbonate), or a haloformate (such as dihaloformate of a divalent phenol)] by a conventional method (such as interfacial polycondensation method and transesterification method). Among these, a polycarbonate from the interfacial polycondensation method is preferable as component (B). The polycarbonate resin may have a linear or branched structure. Furthermore, one polycarbonate resin may be used singly or two or more polycarbonate resins may be used in combination.

The viscosity average molecular weight of component (B) is preferably 19,000 to 30,000, more preferably 20,000 to 29,000, and further preferably 21,000 to 28,000. When component (B) has a viscosity average molecular weight of less than 19,000, molded articles are inferior in flame retardancy and flexural strength.

The viscosity average molecular weight (Mv) of component (B) herein is a value calculated from the Schnell's viscosity equation: [η]=1.23×10⁻⁴ Mv^{0.83}, wherein the intrinsic viscosity ([η]) (unit: dl/g) at a temperature of 20° C. is determined using methylene chloride as the solvent and an Ubbelohde viscometer.

In a total amount of 100% by mass of component (A) and component (B), the proportion of component (A) is 40 to 100% by mass, preferably 40 to 80% by mass, and more preferably 40 to 60% by mass, and the proportion of component (B) is 60 to 0% by mass, preferably 60 to 20% by mass, and more preferably 60 to 40% by mass.

The ratio of the viscosity average molecular weight of component (A) to the viscosity average molecular weight of component (B), (A)/(B), is preferably 0.7 to 1.5, more preferably 0.75 to 1.45, and further preferably 0.8 to 1.4.

As the carbon fibers of component (C), any of cellulose-based, polyacrylonitrile-based, and pitch-based carbon fibers, for example, can be used. Alternatively, it is also possible to use carbon fibers obtained by methods of spinning without an infusibilizing step, typified by a method of spinning or molding a raw material composition composed of a polymer obtained by methylene linkage of an aromatic sulfonic acid or a salt thereof and a solvent followed by carbonization. Furthermore, it is also possible to use carbon fibers produced by a method without a spinning step, typified by a vapor deposition method.

It is further possible to use any of so-called general-purpose type, medium elastic modulus type, and high elastic modulus type carbon fibers. Examples of the shape thereof include chopped fibers and roving, and the carbon fibers are preferably chopped fibers. The fiber length of the chopped fibers is 1 to 40 mm, for example, and preferably around 3 to 10 mm. With respect to the production method, either of melt spinning and solvent spinning can be used. In the case of solvent spinning, either of wet spinning and dry spinning can be used.

As component (C), carbon fibers surface-treated with a resin are preferable. The carbon fibers surface-treated with a resin are those subjected to a surface treatment of coating the surface of untreated carbon fibers with a resin. As the resin, one or more resins selected from a polyamide, a polyurethane, and an epoxy are preferable, and a polyamide is more preferable.

When the carbon fibers are surface-treated with a polyamide, a water-soluble polyamide or a polyamide resin dispersion is preferably used to provide a surface treatment of coating the surface of untreated carbon fibers with the polyamide. Examples of the water-soluble polyamide include “KP2021A”, “KP2021A”, and “KP2007” manufactured by Matsumoto Yushi-Seiyaku Co., Ltd. and “AQ Nylon” manufactured by Toray Industries, Inc. Examples of the polyamide resin dispersion include dispersions obtained by allowing a polyamide resin to be subjected to dispersion treatment using polyvinyl pyrrolidone, polyethylene glycol, or the like.

Examples of polyamides that may be used for the surface treatment include polyamides having a tertiary amine in the main chain or the side chain and polyamides having a polyalkylene glycol component in the main chain. To obtain a polyamide having a tertiary amine, monomers including a tertiary amine in the main chain (e.g., nylon, aminoethylpiperazine, and bisaminopropylpiperazine) and monomers including a tertiary amine in the side chain (e.g., α-dimethylamino ε-caprolactam) may be used.

Component (C) is blended in an amount of 10 to 60 parts by mass, preferably in an amount of 15 to 55 parts by mass, and more preferably in an amount of 20 to 50 parts by mass, relative to a total of 100 parts by mass of component (A) and component (B). With less than 10 parts by mass of component (C), molded articles have insufficient flexural modulus and are inferior in material strength. With more than 60 parts by mass of component (C), molded articles are inferior in flame retardancy.

As the phosphate compound of component (D), those known may be used. For example, those described in paragraphs 0030 and 0031 of JP-A 2005-15692 as follows may be used.

That is, examples of component (D) can include triphenyl phosphate, tricresyl phosphate, trixylenyl phosphate, tris(isopropylphenyl)phosphate, tris(o- or p-phenylphenyl) phosphate, trinaphthyl phosphate, cresyldiphenyl phosphate, xylenyldiphenyl phosphate, diphenyl(2-ethylhexyl) phosphate, di(isopropylphenyl)phenyl phosphate, o-phenylphenyldicresyl phosphate, tris(2,6-dimethylphenyl) phosphate, tetrakis(2,6-dimethylphenyl)-m-phenylene bisphosphate, tetraphenyl-m-phenylene diphosphate, tetraphenyl-p-phenylene diphosphate, phenyl resorcin-polyphosphate, bisphenol A-bis(diphenylphosphate), bisphenol A-polyphenyl phosphate, and dipyrocatechol hypodiphosphate.

As others, examples of aliphatic-aromatic phosphates can include orthophosphates such as diphenyl(2-ethylhexyl) phosphate, diphenyl-2-acryloyloxyethyl phosphate, diphenyl-2-methacryloyloxyethyl phosphate, phenyl neopentyl phosphate, pentaerythritol diphenyl diphosphate, and ethylpyrocatechol phosphate, and condensates thereof.

When the phosphate is a condensate, it is possible to use an aromatic phosphate represented by general formula (I) described in paragraphs 0032 to 0038 of JP-A 2005-15692. As the aromatic phosphate represented by general formula (I), an aromatic phosphate having an aromatic group substituted by a hydroxyl group is preferable. Examples of such an aromatic phosphate include those having one, or two or more hydroxyl groups in tricresyl phosphate or triphenyl phosphate. For example, resorcinol diphenyl phosphate and bisphenol A diphenyl phosphate are preferable.

As the aromatic phosphate, PX-110 (cresyl di 2,6-xylenyl phosphate), PX-200, PX-202, CR-733S, and CR-741 (all of them are sold by DAIHACHI CHEMICAL INDUSTRY CO., LTD. as flame retardants and included in the aromatic phosphate represented by general formula (I) above), and DAIGUARD-4000 (DAIHACHI CHEMICAL INDUSTRY CO., LTD.), as trade names, may be used.

Component (D) is blended in an amount of 20 to 40 parts by mass, preferably in an amount of 22 to 37 parts by mass, and more preferably in an amount of 25 to 35 parts by mass, relative to a total of 100 parts by mass of component (A) and component (B). With less than 20 parts by mass of component (D), molded articles are inferior in flame retardancy. With more than 40 parts by mass of component (D), the thermal stability on molding and the heat resistance of molded articles are inferior.

As the fluorine compound of component (E), a fluorine resin is preferable. Examples of the fluorine resin include homopolymers such as polyvinyl fluoride (PVF), polyvinylidene fluoride (PVDF), polytrifluoroethylene (PTrFE), polychlorotrifluoroethylene, and polytetrafluoroethylene (PTFE), ethylene-tetrafluoroethylene copolymers, ethylene-chlorotrifluoroethylene copolymers, tetrafluoroethylene-hexafluoropropylene copolymers, and tetrafluoroethylene-perfluoropropyl vinyl ether copolymers.

One of these fluorine resins may be used singly or two or more of these may be used in combination. Among these fluorine resins, tetrafluoroethylene homopolymers such as polytetrafluoroethylene (PTFE) or copolymers including tetrafluoroethylene as the main constituent are preferable.

Component (E) is blended in an amount of 0.01 to 1 parts by mass, preferably in an amount of 0.05 to 0.8 parts by mass, and more preferably in an amount of 0.1 to 0.7 parts by mass, relative to a total of 100 parts by mass of component (A) and component (B). With less than 0.01 parts by mass of component (E), the flammability is inferior. With more than 1 part by mass of component (E), the moldability and surface appearance are inferior.

The composition of the present invention may contain conventional additives (except those corresponding to component (A) to component (E)), for example, a stabilizer (e.g., an antioxidant, an ultraviolet absorber, and a light stabilizer), a slip agent, a colorant (such as a dye and a pigment), an antistatic agent, a flame retardant (such as a halogen-based flame retardant and an inorganic flame retardant), a flame-retardant aid, a crosslinking agent, reinforcing material, a nucleant, a coupling agent, a dispersant, an antifoaming agent, a fluidizer, a dripping inhibitor, an antimicrobial agent, a preservative, a viscosity modifier, a thickener, a plasticizer, and the like, depending on applications.

The composition of the present invention may be prepared by dry- or wet-mixing each component using a mixing apparatus, for example, a tumbler mixer, a Henschel mixer, a ribbon mixer, or a kneader.

Additionally, it is possible to apply a method of preparing pellets of the composition by premixing the components using the mixer and then kneading the premix in a single-screw or twin-screw extruder or a method of preparing the composition by melting and kneading the components in a kneader such as a heating roll and a Banbury mixer.

The composition of the present invention can be molded into various molded articles by injection molding, extrusion molding, vacuum molding, profile molding, foam molding, injection press, press molding, blow molding, gas injection molding, or the like.

The molded article of the present invention is a molded article obtained (molded) from the polycarbonate resin composition of the present invention.

The molded articles of the present invention can be used for parts and housings, for example, in the field of OA and consumer appliances, the electric and electronic field, the communication equipment field, the sanitary field, the field of transport vehicles such as automobiles, the housing-related field such as furniture and building materials, the field of miscellaneous goods, and the like.

### EXAMPLES

### Component (A)

A-1: a recycled aromatic polycarbonate resin (recycled product recovered from water bottles of used water servers shipped to the market), viscosity average molecular weight: 25,000

A-2: a recycled aromatic polycarbonate resin (recycled product recovered from used pachinko base control boxes shipped to the market), viscosity average molecular weight: 23,000

A-3: a recycled aromatic polycarbonate resin (recycled product recovered from used silicon wafer transport cases shipped to the market), viscosity average molecular weight: 21,000

A-4: a recycled aromatic polycarbonate resin (recycled product recovered from used DVD optical disks shipped to the market), viscosity average molecular weight: 16,000

### Component (B)

B-1: an aromatic polycarbonate resin (Iupilon S-1000F, manufactured by Mitsubishi Engineering-Plastics Corporation), viscosity average molecular weight: 27,000

B-2: an aromatic polycarbonate resin (Iupilon S-2000F, manufactured by Mitsubishi Engineering-Plastics Corporation), viscosity average molecular weight: 23,000

B-3: an aromatic polycarbonate resin (Iupilon S-3000F, manufactured by Mitsubishi Engineering-Plastics Corporation), viscosity average molecular weight: 19,000

B-4: an aromatic polycarbonate resin (Makrolon OD2015, manufactured by Bayer Material Science AG), viscosity average molecular weight: 16,000

### Component (C)

C-1: 6-mm long chopped carbon fibers surface-treated with a water-soluble polyamide resin (ACECA-6HT2, manufactured by ACE C & TECH Co., LTD.)

### Component (D)

D-1: tetrakis(2,6-dimethylphenyl)-m-phenylene bisphosphate (CR741, manufactured by DAIHACHI CHEMICAL INDUSTRY CO., LTD.)

### Component (E)

E-1: polytetrafluoroethylene (PTFE CD145E, manufactured by ASAHI GLASS CO., LTD.)

### Other Components

Stabilizer (1): tris(2,4-di-t-butylphenyl)phosphite (Adekastab 2112, manufactured by ADEKA CORPORATION)

Stabilizer (2): 3,9-bis{2-[3-(3-tert-butyl-4-hydroxy-5-methylphenyl)propionyloxy]-1,1-dimethyl}-2,4,8,10-tetraoxaspiro[5,5]undecane (Adekastab AO-80, manufactured by ADEKA CORPORATION)

Stabilizer (3): epoxidized soybean oil (Adeka Sizer O-130P, manufactured by ADEKA CORPORATION)

Slip agent: polyglyceryl fatty acid ester (RIKEMAL AZ-01, manufactured by RIKEN VITAMIN Co., Ltd.)

### Examples and Comparative Examples

The components were each blended in the composition shown in Table 1 (component (A) and component (B): a total of 100% by mass, the remaining components: parts by mass relative to a total of 100 parts by mass of component (A) and component (B)) and mixed in a Henschel mixer. Thereafter, the mixture was supplied to a twin screw extruder and melted and kneaded therein at 280° C. to provide pellets. These pellets were injection-molded under the following conditions to produce each specimen. The specimens were subjected to each measurement described below. The results are shown in Table 1.

### (Injection Molding Conditions)

Molding apparatus: 100MS-II manufactured by Mitsubishi Heavy Industries, Ltd. (mold clamping force: 100 t), cylinder diameter: 36 mm

Molding temperature: 280° C., mold temperature: 80° C.

### (1) Flame Retardant Test

The vertical burning test specified in UL-94 was conducted. The specimen has a thickness of 0.8 mm. “NOT-V” in Table 1 shows that the specimen does not reach any of the V levels of UL94-V standard.

### (2) Flexural Modulus and Flexural Strength Test

The flexural modulus (unit: GPa) and flexural strength (unit: MPa) were determined in compliance with ISO 178.

TABLE 1

| | | Examples | | | | | | | | |
|---|---|---|---|---|---|---|---|---|---|---|
| | | 1 | 2 | 3 | 4 | 5 | 6 | 7 | 8 | 9 |
| (A) | A-1 | 50 | 50 | 50 | | | 70 | 90 | 50 | 50 |
| | A-2 | | | | 50 | | | | | |
| | A-3 | | | | | 50 | | | | |
| | A-4 | | | | | | | | | |
| Viscosity average | | 25000 | 25000 | 25000 | 23000 | 21000 | 25000 | 25000 | 25000 | 25000 |
| molecular weight | | | | | | | | | | |
| of component (A) | | | | | | | | | | |
| (B) | B-1 | 50 | | | 50 | 50 | 30 | 10 | 50 | 50 |
| | B-2 | | 50 | | | | | | | |
| | B-3 | | | 50 | | | | | | |
| | B-4 | | | | | | | | | |
| Viscosity average | | 27000 | 23000 | 19000 | 27000 | 27000 | 27000 | 27000 | 27000 | 27000 |
| molecular weight | | | | | | | | | | |
| of component (B) | | | | | | | | | | |
| (A)/(B) (molecular | | 0.93 | 1.09 | 1.32 | 0.85 | 0.78 | 0.93 | 0.93 | 0.93 | 0.93 |
| weight ratio) | | | | | | | | | | |
| (C) | C-1 | 32.5 | 32.5 | 32.5 | 32.5 | 32.5 | 32.5 | 32.5 | 15 | 50 |
| (D) | D-1 | 28 | 28 | 28 | 28 | 28 | 28 | 28 | 28 | 28 |
| (E) | E-1 | 0.7 | 0.7 | 0.7 | 0.7 | 0.7 | 0.7 | 0.7 | 0.7 | 0.7 |

| | | | | | | | | | |
|---|---|---|---|---|---|---|---|---|---|
| Stabilizer (1) | 0.1 | 0.1 | 0.1 | 0.1 | 0.1 | 0.1 | 0.1 | 0.1 | 0.1 |
| Stabilizer (2) | 0.1 | 0.1 | 0.1 | 0.1 | 0.1 | 0.1 | 0.1 | 0.1 | 0.1 |
| Stabilizer (3) | 0.2 | 0.2 | 0.2 | 0.2 | 0.2 | 0.2 | 0.2 | 0.2 | 0.2 |
| Slip agent | 0.1 | 0.1 | 0.1 | 0.1 | 0.1 | 0.1 | 0.1 | 0.1 | 0.1 |
| Flame retardancy | V-0 | V-0 | V-0 | V-0 | V-0 | V-0 | V-0 | V-0 | V-0 |
| Flexural modulus (GPa) | 17.1 | 17.1 | 16.9 | 16.8 | 16.6 | 16.7 | 16.5 | 11.2 | 21.1 |
| Flexural strength (MPa) | 200 | 210 | 200 | 200 | 190 | 220 | 150 | 200 | 230 |

| | | Examples | Comparative Examples | | | | | | |
|---|---|---|---|---|---|---|---|---|---|
| | | 10 | 1 | 2 | 3 | 4 | 5 | 6 | 7 |
| (A) | A-1 | 25 | | 50 | | 50 | 50 | 50 | 50 |
| | A-2 | | | | | | | | |
| | A-3 | | | | | | | | |
| | A-4 | 25 | 50 | | 50 | | | | |
| Viscosity average | | 20500 | 16000 | 25000 | 16000 | 25000 | 25000 | 25000 | 25000 |
| molecular weight | | | | | | | | | |
| of component (A) | | | | | | | | | |
| (B) | B-1 | | 50 | | | 50 | 50 | 50 | 50 |
| | B-2 | 50 | | | | | | | |
| | B-3 | | | | | | | | |
| | B-4 | | | 50 | 50 | | | | |
| Viscosity average | | 23000 | 27000 | 16000 | 16000 | 27000 | 27000 | 27000 | 27000 |
| molecular weight | | | | | | | | | |
| of component (B) | | | | | | | | | |
| (A)/(B) (molecular | | 0.89 | 0.59 | 1.56 | 1.00 | 0.93 | 0.93 | 0.93 | 0.93 |
| weight ratio) | | | | | | | | | |
| (C) | C-1 | 50 | 32.5 | 32.5 | 32.5 | 32.5 | 32.5 | 5 | 70 |
| (D) | D-1 | 28 | 28 | 28 | 28 | | 28 | 28 | 28 |
| (E) | E-1 | 0.7 | 0.7 | 0.7 | 0.7 | 0.7 | | 0.7 | 0.7 |

| | | | | | | | | |
|---|---|---|---|---|---|---|---|---|
| Stabilizer (1) | 0.1 | 0.1 | 0.1 | 0.1 | 0.1 | 0.1 | 0.1 | 0.1 |
| Stabilizer (2) | 0.1 | 0.1 | 0.1 | 0.1 | 0.1 | 0.1 | 0.1 | 0.1 |
| Stabilizer (3) | 0.2 | 0.2 | 0.2 | 0.2 | 0.2 | 0.2 | 0.2 | 0.2 |
| Slip agent | 0.1 | 0.1 | 0.1 | 0.1 | 0.1 | 0.1 | 0.1 | 0.1 |
| Flame retardancy | V-0 | V-2 | V-2 | V-2 | NOT-V | NOT-V | V-0 | NOT-V |
| Flexural modulus (GPa) | 20.1 | 15.3 | 15.6 | 14.5 | 16.4 | 16.6 | 6.5 | 20.8 |
| Flexural strength (MPa) | 200 | 140 | 130 | 90 | 190 | 200 | 80 | 180 |

In a recycled aromatic polycarbonate resin as component (A), especially a post-consumer recycled product, fluctuations in the quality of the aromatic polycarbonate resin contained therein increase. Thus, fluctuations in the quality of molded articles obtained from a composition containing component (A) also increase. According to the present invention, fluctuations in the quality in the case of use of a recycled aromatic polycarbonate resin are suppressed by adjusting the type and content of each component other than component (A) to thereby achieve an improved effect.

1. A polycarbonate resin composition comprising,
relative to 100 parts by mass of a resin composed of:
(A) 40 to 100% by mass of a recycled aromatic polycarbonate resin; and
(B) 0 to 60% by mass of an aromatic polycarbonate resin to amount to a total of 100% by mass,
(C) 10 to 60 parts by mass of carbon fibers,
(D) 20 to 40 parts by mass of a phosphate compound, and
(E) 0.01 to 1 part by mass of a fluorine compound,
wherein the component (A) has a viscosity average molecular weight of 19,000 to 30,000, and the component (B) has a viscosity average molecular weight of 19,000 to 30,000.

2. The polycarbonate resin composition according to claim 1, wherein the ratio of the viscosity average molecular weight of the component (A) to the viscosity average molecular weight of component (B), (A)/(B), is 0.7 to 1.5.

3. The polycarbonate resin composition according to claim 1, wherein the component (A) is an aromatic polycarbonate resin recovered from one or more molded articles selected from optical recording media, beverage containers, optical components, electronic component enclosures, transport cases for electronic components, and building materials.

4. A molded article obtained from the polycarbonate resin composition according to claim 1.
